(19) United States
(12) Patent Application Publication
(10) Pub. No.: US 2017/0018751 A1
(43) Pub. Date: Jan. 19, 2017

(54) CONNECTOR FOR ELECTRICALLY CONTACTING ARRESTERS OF AN ELECTROCHEMICAL CELL

(71) Applicant: Karlsruher Institut fuer Technologie, Karlsruhe (DE)

(72) Inventors: Manuel Baumeister, Bruchsal (DE); Andreas Gutsch, Luedinghausen (DE); Juergen Fleischer, Karlsruhe (DE)

(73) Assignee: Karsruher Institut fuer Technologie, Karlsruhe (DE)

(21) Appl. No.: 15/124,357

(22) PCT Filed: Jan. 22, 2015
(86) PCT No.: PCT/EP2015/000110

§ 371 Date: Sep. 8, 2016

(30) Foreign Application Priority Data
Mar. 10, 2014 (DE) 10 2014 103 128.8

(51) Int. Cl. H01M 2/20; H01R 13/22; H01M 10/653; H01M 10/0525; H01M 10/647

(52) U.S. Cl. CPC H01M 2/206; H01M 10/0525; H01M 10/647; H01M 10/653; H01R 13/22; H01M 2220/20

(57) ABSTRACT

A connector for electrically contacting arresters of electrochemical cells includes a base element having two opposing flat sides, one or more contacting elements arranged on at least one of the two fiat sides. The one or more contacting elements extend in a contacting direction transversely to the flat sides.

### CROSS REFERENCE TO RELATED APPLICATIONS

This application is a U.S. National Stage Application under 35 U.S.C. §371 of International Application No. PCT/EP2015/000110 filed on Jan. 22, 2015, and claims benefit to German Patent Application No. DE 10 2014 103 128.8 filed on Mar. 10, 2014. The International Application was published in German on Sep. 17, 2015 as WO 2015/135612 Al under PCT Article 21(2).

### FIELD

The invention relates to a connector for electrically contacting arresters of an electrochemical cell, to an arrester of an electrochemical cell and to a battery comprising an electrical connection arrangement between arresters of at least two electrochemical cells.

### BACKGROUND

In order to provide higher electrical power from electrochemical stores, in particular from batteries, such as the power that is necessary for electric vehicles, it is known to combine a plurality of cells into a larger battery module. In order to achieve a sufficiently high output voltage, battery cells of a battery module are electrically connected in series, for which purpose it is necessary to alternately interconnect the anode arresters and cathode arresters of adjacent battery cells arranged in a stack. In order to achieve a sufficiently high output current, battery cells of a battery module are electrically connected in parallel, for which purpose it is necessary to interconnect the anode arresters and to interconnect the cathode arresters, respectively, of adjacent battery cells arranged in a stack. For specific applications, series and parallel connections of battery cells are usually combined. In this case, the contact resistance at contact points is important, since it defines the electrical power loss of the connection.

Modern battery blocks often consist of flat cells in the form of lithium-based pouch cells that have, as a core, a stack of alternately layered anode foils and cathode foils which are each separated from one another by separator foils. The foil stack is accommodated in a housing foil that has a peripheral sealed seam. A flat cathode arrester and a flat anode arrester are guided out of the sealed seam of the flat cell and are used to electrically interconnect the flat cells.

Clamping connections comprising clamping screws are known for connecting arresters of battery cells. However, a clamping connection of this kind for arresters is not particularly suitable on account of the load on the arrester caused by the clamping screw.

Furthermore, it is possible to connect the arresters by means of welding, screwing, riveting or optionally adhesively bonding. Welding has the disadvantage that heat is introduced. This should be avoided so as to not damage the cells. Screwing results in increased assembly costs. Riveting also results in increased assembly costs. Adhesive bonding is suitable only to a limited degree on account of the insulating effect of plastics materials, but is possible using specific adhesives. Apart from the screw connection, these joining methods are permanent connection techniques.

DE 10 2008 049 852 A1 discloses an apparatus for electrically connecting arresters of battery cells, in particular pouch cells, in which a first contact element comprising a first guide device and a second guide device is provided, wherein the first guide device abuts a first arrester and the second guide device abuts a second arrester. Furthermore, a second contact element comprising a first retaining device and a second retaining device is provided, wherein the first retaining device surrounds the first guide device and the first arrester, and the second retaining device surrounds the second guide device and the second arrester. The fact that the guide devices abut the arresters results in an electrical contact between the guide devices and the arresters. The retaining devices surround the guide devices and the arresters such that the guide devices and the arresters are pressed together.

### SUMMARY

In an embodiment, the present invention provides a connector for electrically contacting arresters of electrochemical cells, the connector including a base element having first and second opposing flat sides, one or more contacting elements arranged on at least one of the flat sides. The one or more contacting elements extend in a contacting direction transversely to the flat sides.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is an isometric view of a connector for electrically contacting arresters of electrochemical cells according to an embodiment of the invention, in which contacting elements are arranged on one of the flat sides of the base element;

FIG. 2 is an isometric view of a connector for electrically contacting arresters of electrochemical cells according to a further embodiment of the invention, in which contacting elements are arranged on both of the flat sides of the base element;

FIG. 3 is an isometric view of an arrester of an electrochemical cell according to an embodiment of the invention;

FIG. 4 is an isometric view of an arrester of an electrochemical cell comprising a press-fitted connector according to an embodiment of the invention; and

FIG. 5 is an isometric view of a battery module consisting of a plurality of electrochemical cells that are connected to electrical contact arrangements according to an embodiment of the invention.

### DETAILED DESCRIPTION

An embodiment of the invention provides a connector for electrically contacting arresters of electrochemical cells which allows simple and secure assembly and low power loss. Further embodiments of the invention provide an arrester of an electrochemical cell in such a way that it is possible to assemble the connection apparatus in a simple and secure manner while having low power loss, and provide an electrochemical store having at least two cells which can be connected in a simple and secure manner while having low power loss.

Embodiments of the invention provide a connector for electrically contacting arresters of electrochemical cells, a base element that comprises two opposing flat sides being provided. In this case, one or more contacting elements are arranged on at least one of the two flat sides, which elements extend in a contacting direction transversely to the flat sides.

The connector according to an embodiment of the invention for electrically contacting arresters of electrochemical cells includes a base element that can be formed as a cuboid for example and comprises, on at least one of the two flat sides, contacting elements that project from the at least one flat side and can be pressed into pre-drilled arrester plates for the purpose of contacting. In this case, the number of contacting elements can vary depending on the size of the arrester and the desired contact resistance of the connector-arrester connection. It is advantageous for the electrical connections to be able to withstand high currents, since high peak currents can occur, in particular when a battery module is used in motor vehicles. Consequently, low contact resistance values and thus low power losses are desirable in the electrical connections of electrochemical cells, and this is promoted by increasing the number of contact elements that are connected in parallel.

Embodiments of the invention provide a connector having the advantages of high mechanical strength of the connection combined with a low electrical contact resistance on account of the interlocked and integral connection created. At the same time, the contacting can also be released and re-connected again by increasing the press-fitting pressure during the subsequent contacting, and thus a corresponding interlocked and integral connection can again be achieved. This ensures the reparability of the contacting.

It is particularly expedient if the cross section of the contacting elements reduces in the contacting direction, which corresponds to the pressing direction. The contacting elements can taper conically for example. The reduction in the cross section in the contacting direction means that a process of pressing into corresponding openings in an arrester of an electrochemical cell is to be seen as expedient since the contacting elements can be easily introduced into the openings until the diameter of the contacting element reaches the diameter of the opening. A secure connection between the connector and the arrester can thus be achieved by further increasing the press-fitting pressure, and by plastic deformation of the contacting element that may result therefrom. A low contact resistance can thus be achieved by means of this interlocked and, as far as possible, optionally integral connection.

One possibility for the design having a tapering cross section is for the contacting elements to be conical, in particular in the form of a truncated cone, the wider cross section thereof facing the relevant flat side. The contacting elements can thus be securely press-fitted into round openings in an arrester.

A further embodiment can provide for the contacting elements to be in the form of a truncated pyramid, the wider cross section of which faces the relevant flat side. Contacting elements designed in this manner can also be securely press-fitted into in particular circular, but also angular, openings in an arrester. Alternatively, the contacting elements may also be circular, triangular or polygonal in plan view.

In a further embodiment, however, it is also possible for the contacting elements to be cylindrical and to be press-fitted into correspondingly chamfered drill holes in an arrester. A connection of this kind can also be designed so as to be secure and so as to have a low contact resistance if the fit of the contacting elements is selected so as to be suitable for press-fitting.

In this case, it can also be provided for the contacting elements of a connector to be designed and/or arranged so as to be able to be connected to the arresters without the risk of mistakes. For this purpose, the contacting elements of a connector can, for example, have regions in which the cross sections and/or arrangements are different from those of other regions on the connector.

Advantageously, the connector can be able to be thermally coupled to a heat-dissipating medium. Every electrochemical cell, e.g. battery cell, produces heat when both delivering and consuming current, and this may lead to an increase in the temperature of the overall battery module. In order to prevent damage to the cells and/or to the module composed of the cells, waste heat should be reliably dissipated, and it should also be possible to control the temperature of the battery module if the outside temperature is too low. It is therefore expedient for the connector to be able to be connected to a thermally conductive medium, for example by screwing a corresponding cooling element or a cooling line onto the base element of the connector.

Expediently, the contacting elements can be arranged in the manner of a matrix in regularly spaced rows and columns on the flat side or sides. Advantageous mechanical strength values can thus be achieved when the contacting elements are press-fitted into the arrester of an electrochemical cell, in order to thus provide a stable and lasting connector and arrester assembly. Advantageously, the connector can be formed of a highly thermally conductive metal.

According to a further aspect of the invention, an arrester of a chemical cell comprising a base body is proposed, which arrester is intended to project into the cell in part and to protrude from the cell in part, the protruding region comprising openings that are designed to receive corresponding contacting elements of a described connector. Advantageously, in this case, at least some of the openings can be circular. A shape of this kind is suitable, in an expedient manner, for press-fitting truncated cone-shaped contacting elements, in order to thus ensure secure and lasting contacting with low contact resistance.

In a further embodiment, at least some of the openings can be angular. This shape is again suitable, in an expedient manner, for press-fitting truncated pyramid-shaped contacting elements, in order to ensure secure and lasting contacting with low contact resistance.

According to a further aspect of the invention, an electrochemical store is proposed, comprising an electrical connection arrangement between arresters of at least two electrochemical cells, a base element that comprises opposing flat sides being provided. In this case, one or more contacting elements are arranged on at least one of the two flat sides, the cross section of which elements tapers in a contacting direction transversely to at least one of the flat sides, and which, for the purpose of electrical contacting, can be or are pressed in the contacting direction, transversely to the arrester, into corresponding openings arranged in the arrester for this purpose.

Batteries or accumulators can be used as the electromechanical store. A fuel cell is also conceivable.

Embodiments of the invention provide for an electrical connection arrangement having the advantages of high mechanical strength of the connection together with low electrical contact resistance at the same time on account of the interlocked and integral connection. Advantageously, the contacting can also be released and re-connected again by increasing the press-fitting pressure during the subsequent contacting, and a corresponding interlocked and integral connection can thus again be achieved.

In an advantageous embodiment, one or more contacting elements can be arranged on the two opposite flat sides of the base element. As a result, the connection arrangement can produce contacting of the arresters of two adjacent electrochemical cells by a connector therebetween being pressed into the arrester from both sides.

It is expedient for the openings in the arrester to have a transverse dimension that is smaller than the largest transverse dimension of the contacting elements that corresponds thereto when the contacting elements are pressed into the openings. This ensures that the contacting elements come into contact in the openings in the arrester when press-fitted at a corresponding press-fitting pressure, and that integral contacting can be achieved when the press-fitting pressure is increased.

It is also advantageous for the base element of the connector of the connection arrangement to be connected in a thermally conductive manner to a heat-dissipating medium that is provided in order to dissipate waste heat from the electromechanical store. For example, the connector can be able to be coupled to a heat-conducting pipe and/or to be embedded at least in part in a heat-conducting paste. As a result, waste heat resulting from the chemical processes in the electrochemical cell and from the contact resistance of the contacting can be dissipated in an expedient manner. Furthermore, at low temperatures, for example when a vehicle is started cold, the electrochemical store can thus be set to an appropriate operating temperature by heat being supplied.

In the figures, identical or similar components are denoted by identical reference signs. The figures merely show examples and should not be considered to be limiting.

FIG. 1 is an isometric view of a connector 10 for electrically contacting arresters of electrochemical cells, in particular battery cells, according to an embodiment of the invention, in which a plurality of contacting elements 12 are arranged on a flat side 18 of a base element 16 of the connector 10. The contacting elements 12 extend in a contacting direction 100 transversely to the flat sides 18, 20. In the embodiment shown, the contacting elements 12 are in the shape of a truncated pyramid, the wider cross section of which faces the flat side 18. Alternatively, however, the contacting elements 12 can also taper conically or be formed as truncated cones. The contacting elements 12 are arranged on the flat side or sides 18, 20 in the manner of a matrix in order to thus create a larger number of contacts between the connector 10 and the arrester 52. In this case, the openings in an arrester into which the contacting elements 12 are intended to be pressed expediently have a smaller transverse dimension than the largest transverse dimension 14 of the contacting elements 12 that corresponds thereto when the contacting elements 12 are pressed into the openings.

The connector 10 can be thermally coupled to a heat-dissipating medium, for example by means of screwing a corresponding cooling element or a cooling line to the base element 16 of the connector 10 using a screw thread.

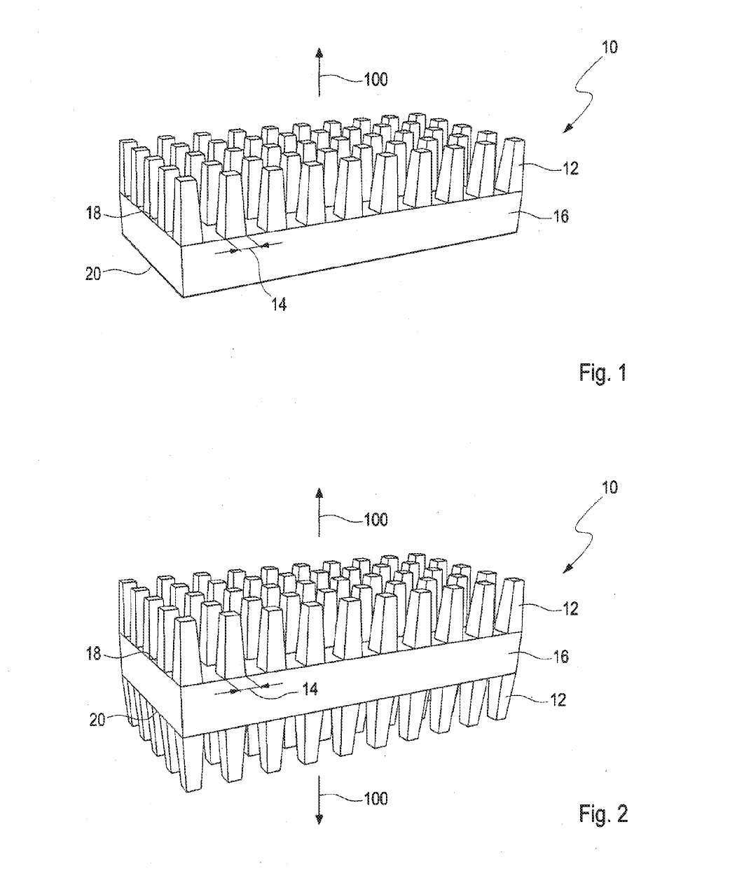

FIG. 2 is a further isometric view of a connector 10 according to a further embodiment of the invention, in which contacting elements 12 are arranged on both flat sides 18, 20 of the base element 16 of the connector 10 and extend in a contacting direction 100 transversely to the flat sides 18, 20. The contacting elements 12 are designed in the same manner as shown in FIG. 1. The arrangement on both flat sides 18, 20 of the base element 16 makes it possible to connect two electrochemical cells, arranged side-by-side, to the connector 10 by connecting two anode arresters when electrochemical cells are connected in parallel, or by connecting an anode arrester to a cathode arrester when electrochemical cells 50, 60 are connected in series.

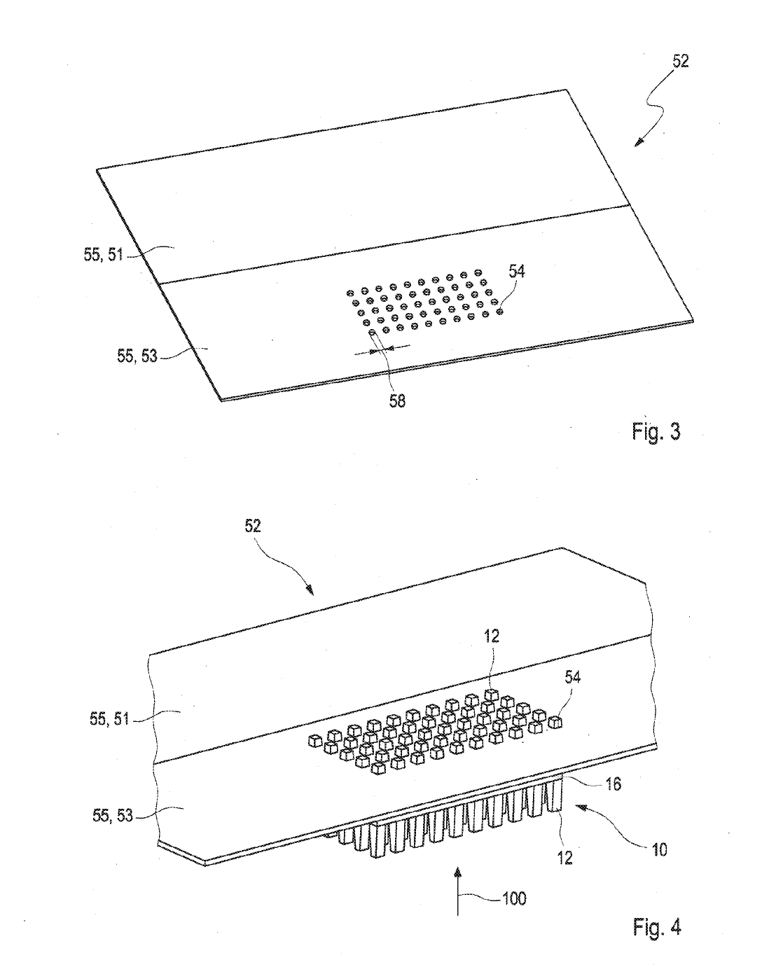

FIG. 3 is an isometric view of an arrester 52 of an electrochemical cell according to an embodiment of the invention. The arrester 52 comprises a base body 55, one region 51 of which is intended to project into the cell and one region 53 of which is intended to protrude from the cell, the part of the arrester 52 that projects into the cell being connected to anode or cathode foils in the cell. The protruding region 53 comprises openings 54 that are designed to receive corresponding contacting elements 12 of a connector 10 (FIGS. 1 and 2). The openings 54 are circular and can thus be formed in the arrester plate by simple drill holes. The openings 54 can thus receive circular conically tapering, truncated cone-shaped or truncated pyramid-shaped contacting elements 12 for example. Alternatively, the openings 54 could also be angular, in order to receive pyramid-shaped contacting elements 12 for example. In this case, the openings 54 in an arrester 52 into which the contacting elements 12 of a connector 10 (FIGS. 1 and 2) are intended to be pressed expediently have a smaller transverse dimension 58 than the largest transverse dimension 14 of the contacting elements 12 that corresponds thereto when the contacting elements 12 are pressed into the openings 54.

FIG. 4 is an isometric view of an arrester 52 of an electrochemical cell comprising a press-fitted connector 10 according to an embodiment of the invention. In FIG. 4, the connector 10 is inserted from below into the openings 54 into the protruding region 53 of the arrester 52 by means of the contacting elements 12, and is pressed in until the pyramid-shaped contacting elements 12 are in abutment in the openings 54 in the arrester 52. Further increasing the pressing pressure makes it possible to achieve an interlocked and integral connection between the contacting elements 12 and the arrester 52, with the result that secure and lasting contacting is achieved between the connector 10 and the arrester 52. For this purpose, the openings 54 in the arrester 52 have a smaller transverse dimension 58 than the largest transverse dimension 14 (FIGS. 1 and 2) of the contacting elements 12 that corresponds thereto the contacting elements 12 are pressed into the openings 54.

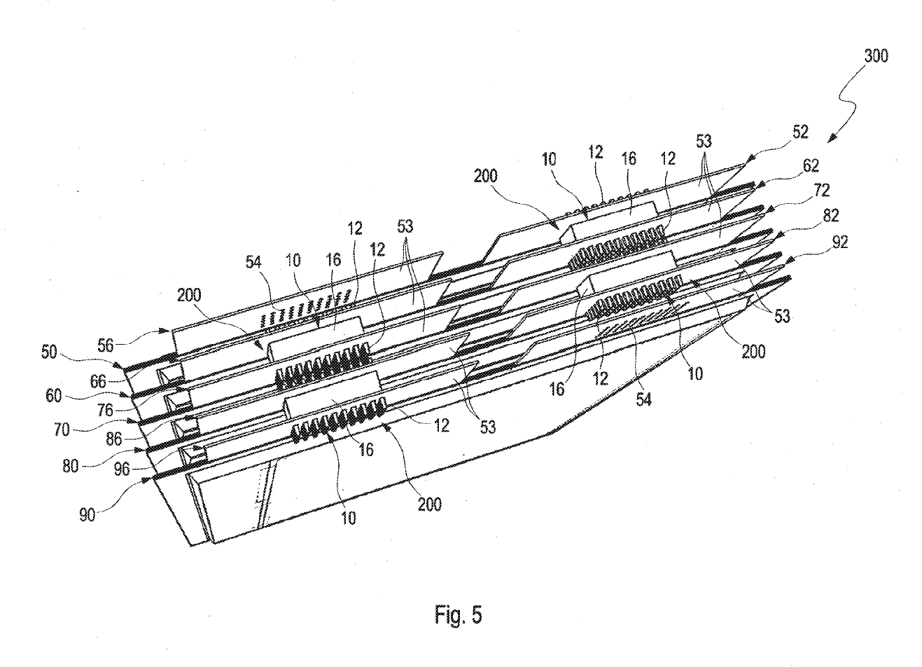

FIG. 5 is an isometric view of an electrochemical store in the form of a module 300 consisting of a plurality of cells 50, 60, 70, 80, 90 that are connected to connection arrangements 200 for electrically contacting the cells 50, 60, 70, 80, 90 according to an embodiment of the invention. In this case, the module 300 consists of a plurality of cells 50, 60, 70, 80, 90 that are arranged beside one another in a stack and are in the form of what are known as pouch cells, as are often used in lithium-based batteries for example.

The figure shows an electrical connection arrangement 200 comprising connectors 10, as depicted in FIGS. 1 and 2. By way of example, contact by means of a connector 10, as depicted in FIG. 2, is shown between the arresters 52 and 62 of the two electrochemical cells 50 and 60. In this case, the connector 10 comprises contacting elements 12 on both flat sides of its base element 16, which contacting elements, for the purpose of electrical contacting, are pressed in the contacting direction 100, transversely to the arresters 52, 62, into corresponding openings 54 arranged in the arresters 52, 62 for this purpose.

In the same way, connection arrangements 200 are shown between the arresters 72, 82, 66, 76, 86, 96 of the other adjacent cells 60, 70, 80 and 90, so the module 300 is connected in series if the arresters 66 and 76 contacted to one another, and the arresters 72 and 82, 86 and 96 of the adjacent cells 50, 60, 70, 80, 90 are in each case anode and cathode arresters, respectively. When the individual cells 50, 60, 70, 80, 90 are connected in this way, the overall voltage of the module 300, as the sum of the individual voltages of the individual cells 50, 60, 70, 80, 90, can then be picked off between the arresters 56 and 92.

In an expedient embodiment, the base elements 16 of the connectors 10 can be connected in a thermally conductive manner to a heat-dissipating medium in order to dissipate the heat produced in the battery cells and/or connection arrangements 200, or in order to also adjust the cells 50, 60, 70, 80, 90 to a desired suitable operating temperature.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

10 connection apparatus
12 contacting element
14 transverse dimension
16 base element
18 flat side
20 flat side
50 electrochemical cell
51 inwardly projecting region
52 arrester
53 protruding region
54 opening
55 base body
56 arrester
58 transverse dimension
60 electrochemical cell
62 arrester
66 arrester
70 electrochemical cell
72 arrester
76 arrester
80 electrochemical cell
82 arrester
86 arrester
90 electrochemical cell
92 arrester
96 arrester
100 contacting direction
200 connection arrangement
300 electrochemical store

1. A connector for electrically contacting arresters of electrochemical cells, comprising:
a base element having first and second opposing flat sides;
one or more contacting elements are arranged on at least one of the flat sides,
wherein the one or more contacting elements extend in a contacting direction transversely to the flat sides.

2. The connector according to claim 1 wherein the cross sections of the contacting elements reduce in the contacting direction.

3. The connector according to claim 1, wherein at least some of the contacting elements are in the shape of a truncated cone, a wider cross section of which faces the flat side on which the at least some of the contacting elements are arranged.

4. The connector according to claim 1, wherein at least some of the contacting elements are in the shape of a truncated pyramid, a wider cross section of which faces the flat side on which the at least some of the contacting elements are arranged.

5. The connector according to claim 1, wherein the contacting elements are arranged in the manner of a matrix in regularly spaced rows and columns on the at least one flat side.

6. An arrester of an electrochemical cell comprising:
a base body, having a first region operable to project into the electrochemical cell in part, and having a second region operable to protrude from the electrochemical cell in part,
wherein the second region includes openings that are operable to receive one or more corresponding contact elements of a connector for electrically contacting arresters of electrochemical cells,
wherein the connector includes a base element having first and second opposing flat sides, and the one or more contacting elements arranged on at least one of the flat sides, the one or more contacting elements extending in a contacting direction transversely to the flat sides.

7. The arrester according to claim 6, wherein at least some of the openings have a circular cross section.

8. The arrester according to claim 6, wherein at least some of the openings have an angular cross section.

9. The arrester according to claim 6, wherein the openings are arranged in the manner of a matrix in regularly spaced rows and columns.

10. An electrochemical store comprising:
an electrical connection arrangement between arresters of at least two storage cells,
wherein the arrester comprises a base element comprising first and second opposing fiat sides, in which one or more contacting elements are arranged on at least one of the flat sides,
wherein the cross section of the one or more contacting, elements tapers in a contacting direction transversely to at least one of the flat sides, and
wherein, for the purpose of electrical contacting, the one or more electrical contacting elements are configured to be pressed in the contacting direction, transversely to the arrester, into corresponding openings arranged in the arresters for this purpose.

11. The electrochemical store according to claim 10, wherein the one or more contacting elements are arranged on both of the flat sides of the base element.

12. The electrochemical store according to claim 10, wherein the openings in the arrester have a smaller transverse dimension than the largest transverse dimension of the contacting elements that corresponds thereto when the contacting elements are pressed into the openings.

13. The electrochemical store according to claim 10, wherein the base element is connected in a thermally conductive manner to a heat-dissipating medium.
